(19) United States
(12) Patent Application Publication
(10) Pub. No.: US 2008/0115325 A1
(43) Pub. Date: May 22, 2008

(54) Dual-axis hinge assembly

(75) Inventor: Hsiang-Chi Chien, Shulin City (TW)

Correspondence Address: CHARLES E. BAXLEY, ESQ., 90 JOHN STREET, THIRD FLOOR, NEW YORK, NY, 10038, US

(73) Assignee: Shin Zu Shing Co., Ltd.

(21) Appl. No.: 11/601,006

(22) Filed: Nov. 17, 2006

(51) Int. Cl. E05D 3/10

(52) U.S. Cl. 16/367

(57) ABSTRACT

A dual-axis hinge assembly has a leaf assembly and a mounting shaft. The leaf assembly has a body and a leaf. The body has a connecting hole formed longitudinally in an end of the body and has multiple protrusions formed on an inner surface of the connecting hole. The leaf is mounted pivotally relative to the body. The mounting shaft has a connecting element, a rotating element connected rotatably to the connecting element and a connector mounted securely on the connecting element. The connector has multiple resilient plates each having a slope portion, a retaining portion and a flat portion to engage with the protrusions of the connecting hole of the body respectively. With such an arrangement, the dual-axis hinge assembly is stably, firmly and conveniently assembled and is easy to be fabricated.

### BACKGROUND OF THE INVENTION

1. Field of the Invention

The present invention relates to a hinge, and more particularly to a dual-axis hinge assembly that is stably, firmly and conveniently assembled and is easy to be fabricated.

2. Description of Related Art

Electronic devices with hinged covers, such as notebook computers, cellular phones and the like are commonly used in daily life. Generally, an electronic device comprises a base, a cover and a hinge. The cover has a display. The hinge pivotally connects the cover to the base, and the cover is pivoted away from the base when the electronic device is in use.

To provide additional flexibility, dual-axis hinges have been further developed to allow the cover to be rotated after the cover being pivoted away from the base.

A conventional dual-axis hinge mainly comprises a body, a pintle, a mounting leaf and a mounting shaft.

The body is tubular and has two ends. The pintle is mounted rotatably inside and protrudes transversely from the body and has a lower end. The mounting leaf is mounted securely around the pintle between the lower end of the pintle and the body and attaches to a base of an electronic device. The mounting shaft is connected to one end of the body and has a rotating element mounted securely with a base of an electronic device. With such an arrangement, the dual-axis hinge allows the cover to lift from and rotate horizontally relative to the base.

However, the mounting shaft of the conventional dual-axis hinge is connected to the body by means of riveting, gluing, welding etc. This is not only causing fabrication of the conventional dual-axis hinges time consuming, but also causing the connection between the mounting shaft and the body unstable and unsecured. The mounting shaft of the conventional dual-axis hinge is easily disengaged from the body.

To overcome the shortcomings, the present invention provides a dual-axis hinge assembly to obviate or mitigate the aforementioned problems.

### SUMMARY OF THE INVENTION

The main objective of the present invention is to provide a dual-axis hinge assembly that is stably, firmly and conveniently assembled and is easy to be fabricated.

To achieve the objective, the dual-axis hinge assembly in accordance with present invention has a body, a mounting leaf mounted pivotally on the body and a mounting shaft.

The body has an end and a connecting hole defined in the end. The connecting hole has an opening, an inner surface and multiple protrusions formed radially on the inner surface of the connecting hole. Each one of the protrusions has an end, a side surface and a distance to the opening of the connecting hole.

The mounting shaft has a connecting element and a rotating element connected rotatably to the connecting element. The connecting element has an end and a connector. The end is corresponding to the opening of the connecting hole. The connector is mounted securely in the end and has multiple resilient plates corresponding respectively to the protrusions of the connecting hole of the body. Each resilient plate is bent to form a slope portion, a retaining portion and a flat portion.

To assemble the mounting shaft to the body, the mounting shaft is put into the opening of the connecting hole of the body and pushed to move close to the protrusions. By the slope portions abutting and sliding relative to the protrusions, the resilient plates of the connector is deforming slightly that allow the mounting shaft to keep move. Once the slope portions of the resilient plates pass the protrusions, the flat portions of the resilient plates may abut the ends of the protrusions and the retaining portions of the resilient plates may engage tightly with the protrusions.

With such an arrangement, the connection between the mounting shaft and the body of the dual-axis hinge assembly is stable and firmed. Moreover, assembling of the mounting shaft and the body is convenient, so that fabrication of the dual-axis hinge assembly become easier and faster.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a dual-axis hinge assembly in accordance with the present invention;

FIG. 2 is a partial exploded perspective view of the dual-axis hinge assembly in FIG. 1;

FIG. 3 is a top view in partial section of the dual-axis hinge assembly in FIG. 1; and

FIG. 4 is a side view in partial section of the dual-axis hinge assembly in FIG. 1.

### DETAILED DESCRIPTION OF THE PREFERRED EMBODIMENT

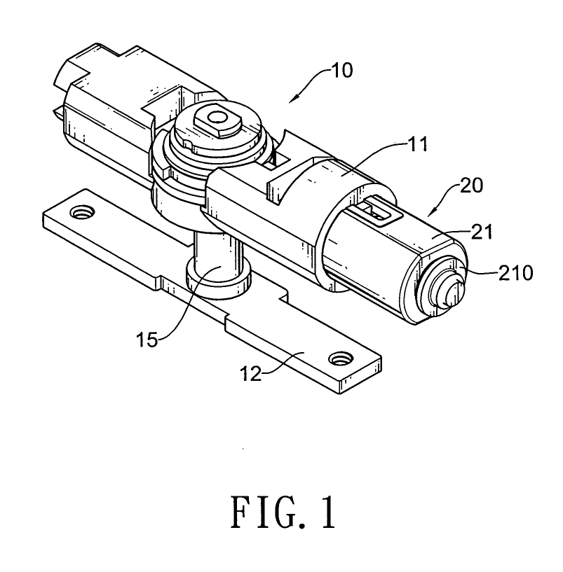

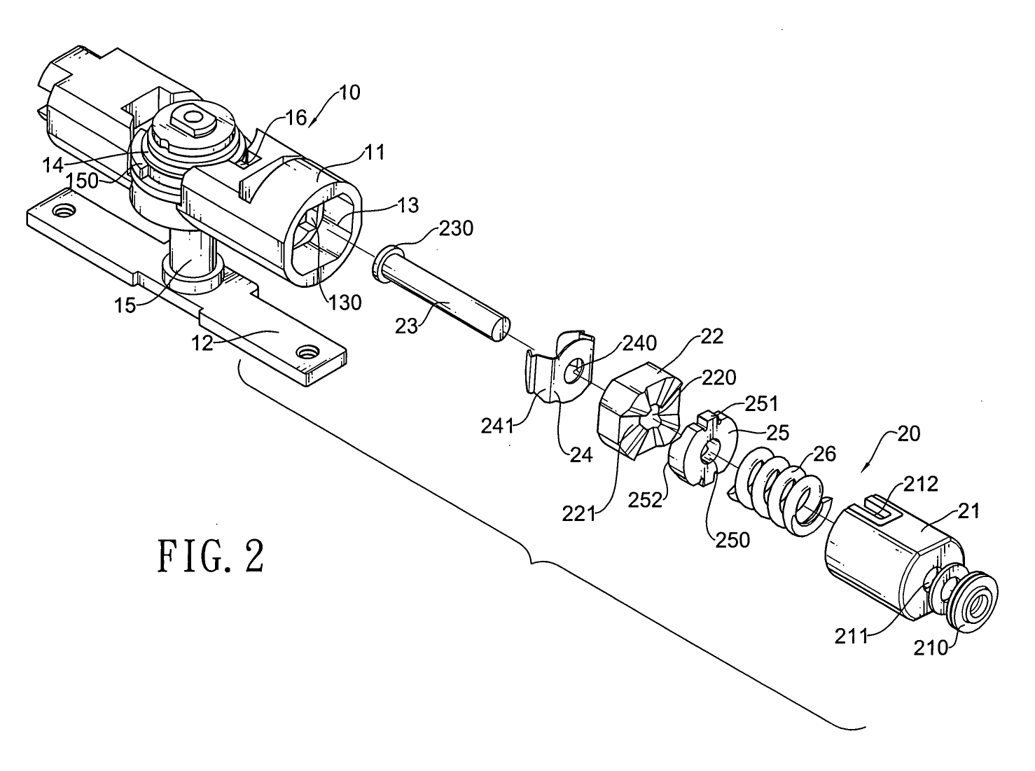

With reference to FIGS. 1 and 2, a dual-axis hinge assembly in accordance with the present invention has a leaf assembly (10) and a mounting shaft (20).

The leaf assembly (10) comprises a body (11), a pintle (15), a mounting leaf (12) and a spring (14).

The body (11) is tubular and has a surface, two ends, a connecting hole (13) and a transverse hole. The connecting hole (13) is formed longitudinally in one end of the body (11) and has an opening, an inner surface and multiple protrusions (130) formed radially on the inner surface of the connecting hole (13). Each one of the protrusions (130) has an end, a side surface and a distance to the opening of the connecting hole (13). The transverse hole is defined radially through the body (11) and has a cavity and a stop (16). The cavity is formed in the surface of the body (11) and communicates to the transverse hole, has an inner surface and communicates with the transverse hole. The stop (16) is formed in the cavity;

The pintle (15) is mounted rotatably in and protrudes out of the transverse hole in the body (11) and has an upper end and a lower end. The upper end of the pintle (15) has a flange and a limit (150). The flange is formed on and protrudes radially out from the upper end, and is received in the cavity. The limit protrudes radially out from the pintle (15) and extends a specific radian.

The mounting leaf (12) is attached to the lower end of the pintle (15) by means of soldering, compression fitting, riveting or the like.

The spring (14) is mounted around the pintle (15) between the flange and the inner surface of the cavity of the body (11) to push the body and facilitate the mounting leaf (12) to rotate relative to the body (11).

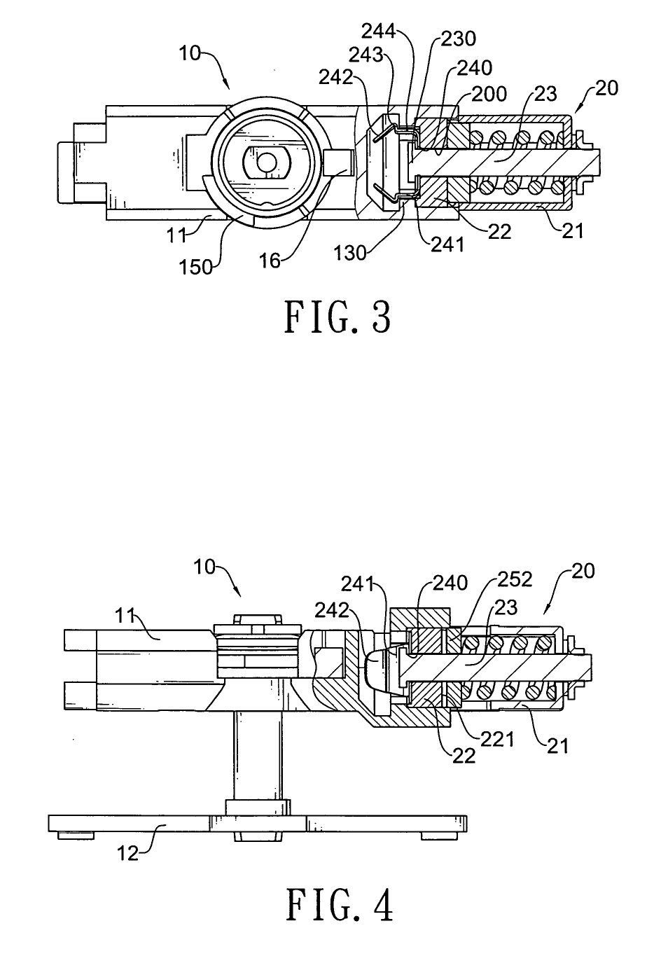

With further reference to FIGS. 3 and 4, the mounting shaft (20) is coaxially mounted securely in the connecting hole (13) and has a rotating element (21), a connecting element (22), a connector (24) and a mounting axle (23).

The rotating element (21) has a space, a first end, a second end, a positioning element (25) and a resilient element (26). The space is defined inside the rotating element (21). The first end has multiple fasteners (210) and a through hole (211) defined in the first end. The second end has an opening and two longitudinal slots (212) formed oppositely to each other. The positioning element (25) is mounting in the opening of the rotating element (21) and has a center hole (250), two bosses (251) and a first engaging surface (252). The bosses (251) protrude oppositely from the positioning element (25) and are held in the slots (212) of the rotating element (21) respectively. The first engaging surface (252) is provided with multiple radial concaves and convexes. The resilient element (26) is mounted in the space of the rotating element (21) and has two ends abutting with the rotating element (21) and the positioning element (25) respectively.

The connecting element (22) is mounted rotatably in the second end of the rotating element (21) and has a mounting hole (220) and a second engaging surface (221). The second engaging surface (221) is provided with multiple radial concaves and convexes and corresponds to and engages with the first engaging surface (252) of the positioning element (25). By the force provided by the resilient element (26), the convaves and convexes on the second engaging surface (221) engage respectively with the convaves and convexes on the first engaging surface (252) to position the connecting element (22) relative to the rotating element (21) at specific angles.

The connector (24) is connected securely to the connecting element (22) and has an aperture (240) with an edge, multiple resilient plates (241) (may be two) corresponding respectively to the protrusions (130) in the connecting hole (13) of the body (11). Each resilient plate (241) has a slope portion (242), a retaining portion (243) and a flat portion (244) formed in sequence.

The mounting axle (23) has an end and a flange (230) and is mounted sequentially through the aperture (240) of the connector (24), the mounting hole (220) of the connecting element (22), the center hole (250) of the positioning element (25), the resilient element (26) and the opening and the through hole (211) of the rotating element (21). The end is secured by the fasteners (210) of the body (11) and the flange (230) abuts with the edge of the aperture (240) of the connector (24) to secure the connector (24) on the connecting element (22).

To assemble the mounting shaft (20) to the body (11), the mounting shaft (20) is put into the opening of the connecting hole (13) of the body (11) and abuts the protrusions (130) with the resilient plates (241) on the connector (24). With the slope portions (242) of the resilient plates (241) on the connector (24) abutting and sliding over the ends of the protrusions (130), the resilient plates (241) of the connector (24) are deformed slightly to allow the resilient plates (241) to move over the protrusions (130). After the slope portions (242) of the resilient plates (241) striding over the protrusions (130), the flat portions (244) of the resilient plates (241) may abut the ends of the protrusions (130) and the retaining portions (243) of the resilient plates (241) may engage tightly with the side surfaces of the protrusions (130). Such that the connection between the mounting shaft (20) and the body (11) of the dual-axis hinge assembly is stable and firmed. Moreover, assembling of the mounting shaft (20) and the body (11) is convenient, so that fabrication of the dual-axis hinge assembly become easier and faster.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A dual-axis hinge assembly comprising
a leaf assembly having
a body being tubular and having
a surface;
two ends; and
a connecting hole being formed longitudinally in one end of the body and having
an opening;
an inner surface and
multiple protrusions formed radially on the inner surface of the connecting hole, each one of the protrusions having an end, a side surface and a distance to the opening of the connecting hole; and
a leaf mounted pivotally relative to the body; and
a mounting shaft having
a connecting element being coaxially mounted in the connecting hole;
a rotating element mounted rotatably to the connecting element; and
a connector being connected securely to the connecting element and having multiple resilient plates corresponding respectively to the protrusions of the connecting hole of the body and each resilient plate having a slope portion, a retaining portion and a flat portion formed in sequence.

2. The dual-axis hinge assembly as claimed in claim 1, wherein
the rotating element of the mounting shaft has
a space formed inside the rotating element;
an opening;
a first end;
a second end having an opening and two longitudinal slots formed oppositely to each other;
a positioning element being mounted in the opening of the rotating element and having
two bosses protruding oppositely from the positioning element and held in the slots of the rotating element respectively; and
a first engaging surface being provided with multiple radial concaves and convexes; and
a resilient element being mounted in the space of the rotating element and having two ends abutting the rotating element and the positioning element respectively; and
the connecting element has a second engaging surface being provided with multiple radial concaves and convexes and corresponding to and engaging with the first engaging surface of the positioning element to position the connecting element relative to the rotating element.

3. The dual-axis hinge assembly as claimed in claim 2, wherein
the connector further has an aperture;
the connecting element further has a mounting hole;
the positioning element further has a center hole;
the rotating element further has a through hole and multiple fasteners; and
a mounting axle is mounted sequentially through the aperture of the connector, the mounting hole of the connecting element, the center hole of the positioning element, the resilient element and the opening and the through hole of the rotating element, and has
an end being secured by the fasteners on the body; and
a flange abutting the edge of the aperture of the connector.

4. The dual-axis hinge assembly as claimed in claim 3, wherein the connector of the mounting shaft has two resilient plates.
